(19) United States
(12) Patent Application Publication
(10) Pub. No.: US 2022/0274633 A1
(43) Pub. Date: Sep. 1, 2022

(54) METHOD FOR OPERATING A SYSTEM HAVING FIRST AND ADDITIONAL MOBILE PARTS AND HAVING A STATIONARY CONTROLLER, AND SYSTEM FOR CARRYING OUT A METHOD

(71) Applicant: SEW-EURODRIVE GMBH & CO. KG, Bruchsal (DE)

(72) Inventor: Frank ERB, Karlsruhe (DE)

(73) Assignee: SEW-EURODRIVE GMBH & CO. KG, Bruchsal (DE)

(21) Appl. No.: 17/637,230

(22) PCT Filed: Jul. 23, 2020
(86) PCT No.: PCT/EP2020/025343

§ 371 Date: Feb. 22, 2022

(30) Foreign Application Priority Data
Aug. 19, 2019 (DE) 10 2019 005 763.5

(51) Int. Cl. B61L 23/34; B61L 3/06; B61L 25/02; B61L 27/57; B61L 23/04

(52) U.S. Cl. CPC B61L 23/34; B61L 3/065; B61L 25/023; B61L 27/57; B61L 23/041; B61L 2201/00

(57) ABSTRACT

In a method for operating a system having first and additional mobile parts and having a stationary controller, and a system for carrying out a method, the system has a connection between the controller and the first mobile part and between the controller and the additional mobile parts. The first mobile part detects and transmits to the controller its position and/or the position of its rear edge, and each additional mobile part detects and transmits to the controller its position and/or the position of its front edge. The controller determines the additional mobile parts most closely adjacent to and following the first mobile part and transmits the position and/or the position of the rear edge of the first mobile part to the additional mobile part. The following mobile part adds its braking distance, to which a safety distance and a safety range are added, to the position and/or to the front edge of the next-closest, following mobile part and monitors this calculated position for collision with the rear edge of the first mobile part.

### FILED OF THE INVENTION

The present invention relates to a method for operating a system having first and additional mobile parts and having a stationary controller, and a system for carrying out a method.

### BACKGROUND INFORMATION

In certain conventional systems, a rail vehicle is followed by another rail vehicle.

A method for operating rail vehicles is described in German Patent Document No. 10 2017 221 812.

German Patent Document No. 10 2008 012 416 discloses a method for the safeguarding of rail-bound vehicles using signal technology.

German Patent Document No. 10 2013 020 523 discloses a method for the reliable monitoring of compliance with a minimum distance for vehicles.

An optoelectronic device is described in German Patent Document No. 10 2004 018 404.

### SUMMARY

Example embodiments of the present invention provide for improving the safety of a rail system.

According to an example embodiment of the present invention, in a method is adapted to operate a system with first and additional mobile parts and a stationary controller, the system including a data exchange connection between the controller and the first mobile part and a data exchange connection between the controller and the additional mobile parts. In a first method step, the first mobile part detects its position and/or determines the position of its rear edge and subsequently transmits the specific values, e.g., the position and the position of the rear edge, to the controller. For example, the direction of travel of the first mobile part is detected and transmitted to the controller, or a direction of travel is stored in the controller as a function of the position of the first mobile part and is transmitted to the first mobile part and/or is provided to the mobile part as the target direction of travel. Each of the additional mobile parts detects its position and/or determines the position of its front edge and transmits the determined values, e.g., the position and the position of the front edge, to the controller. In a second method step, the controller determines which of the additional mobile parts is closest to the first mobile part and following it, and then the position and/or the position of the rear edge of the first mobile part is transmitted thereto. In a third method step, the following mobile part adds its braking distance, to which a safety distance and a safety range are additionally added, e.g., which considers existing response times, dead times, etc., to the position and/or to the front edge of the next-closest, following mobile part, and monitors this calculated position for collision with the rear edge of the first mobile part.

The advantage is that a path, i.e., a vector, is added to the position, i.e., to the corresponding position vector, and thus monitoring can be readily performed. Since the mobile part moves along a trajectory that is predetermined by rails or a track guide, a one-dimensional configuration is made possible in a simple manner. In this case, the position vector can only be represented by a number and the path can also be represented as a number, which must be added to the number representing the position vector. Collision monitoring can thus be readily performed.

The techniques described herein provide for safety for a worker who is between two mobile parts. This is because the detecting of the positions and the determinations as well as the monitoring for collision are carried out in a safety-oriented manner. In this manner, the workspace for the worker can be guaranteed with an increased safety category.

According to example embodiments, the first mobile part has a computer and a camera for recognizing coded regions for determining the position, and the next-closest, following mobile part has a computer and a camera for detecting coded regions for determining the position. The coded regions are arranged successively parallel to the direction of the rails. The advantage is that position detection can be readily determined optically. Thus, coded regions only have to be adhered and/or are attached along the trajectory of the mobile part, which coded regions are detectable by the camera of the mobile part, and the position of the mobile part can be determined therefrom.

According to example embodiments, each additional mobile part has a computer and a camera for detecting coded regions for determining the position thereof, and the next-closest, following mobile part has a computer and a camera for detecting coded regions for determining the position. The coded regions are arranged successively parallel to the direction of the rails. The advantage is that position detection can be readily determined optically. Thus, coded regions only have to be adhered and/or are attached along the trajectory of the mobile part, which coded regions are detectable by the camera of the mobile part, and the position of the mobile part can be determined therefrom.

According to example embodiments, the safety region comprises a person and/or a person can be accommodated in the safety region. The advantage is that a worker can stay in the space between two mobile parts and is not injured because a sufficiently large-enough minimum distance can be maintained in a safety-oriented manner, i.e., with a non-trivial, e.g., high safety category.

According to example embodiments, the first mobile part has a camera for the respective detection of the respective position, the sensitive region of the camera having coded regions which are arranged successively parallel to the direction of travel, e.g., coded regions forming a coding region, which are arranged particularly in a stationary manner. The advantage is that the coded regions contain the information about their respective position and thus the position can be detected through recognition of the coded regions by the camera.

According to example embodiments, the chronological sequence of the respectively detected positions is evaluated for the respective detection of the respective speed. The advantage is that the speed can be readily determined.

According to example embodiments, each coded region has information about its respective position, e.g., for rough positioning. The advantage is that a position determination can be readily performed.

According to example embodiments, an evaluation unit determines the distance of the image from the center of the image from the images taken by the camera of a first of the coded regions and, from this, a shift of the camera to that position of the camera, e.g., for precise positioning, in which the viewing direction of the camera onto the first coded region, e.g., onto the center of the first coded region, occurs as viewed from the center of the image. The advantage is that precise positioning can be readily performed. Because by determining the shift to the center of the image, the shifting of the mobile part to that position can be readily determined, in which the mobile part is arranged directly opposite the first coded region, i.e., the camera has the smallest distance away from the first coded region. Mathematically similar method steps can be carried out, for example, instead of the shortest distance in the viewing direction from the center of the image to the first coded region, a defined angle such as 10°, etc., can also be specified.

According to example embodiments, the direction of travel detected on the first mobile part is monitored when the distance between the position of the rear edge of the first mobile part and the position of the front edge of the next-closest, following mobile part falls below a threshold value. The advantage is that collision monitoring is made possible.

According to example embodiments, the direction of travel detected on the first mobile part is not monitored when the distance between the position of the rear edge of the first mobile part and the position of the front edge of the next-closest, following mobile part exceeds a threshold value. The first mobile part can be controlled by a hand-held control device, e.g., in the reverse direction. For example, the hand-held control device is connected to the first mobile part by an electrical cable. The advantage is that manual control can be carried out if there is sufficient distance.

According to example embodiments, the first mobile part determines the position of its rear edge from its position, e.g., as a function of its position in the system, e.g., different loads are picked up by the first mobile part in different positions. The advantage is that, in a production line, the rear edge is always further removed from the camera due to the installation or the inclusion of additional parts, and the spacing can still be maintained in a safety-oriented manner. For example, if a body of a vehicle to be manufactured is picked up by the mobile part, the rear edge is further away from the camera of the mobile part. If a rear light is also attached to the body, the rear edge is even further away from the camera. Since this picking up and attaching takes place in predetermined regions of the trajectory of the mobile part, the distance between the rear edge and the camera can be uniquely assigned and/or defined as a function of the position of the mobile part within the system.

According to example embodiments, the respective, e.g., the next-closest, mobile part determines the position of its rear edge, from its position, e.g., as a function of its position in the system, e.g., different loads are picked up by the respective mobile part in different positions. The advantage is that the distance of the rear edge from the camera is again defined as a function of the region of the trajectory.

According to an example embodiment of the present invention, in a system for carrying out the aforementioned method, the mobile parts are guided on rails and the coded regions extend parallel to the direction of the rails.

The advantage is that the rail position can be reliably guaranteed by the mobile part being guided mechanically. In addition, the calculations can be carried out one-dimensionally and can therefore be readily performed.

According to example embodiments, the mobile part has an electric motor drive. The advantage is that the mobile part has an energy storage device, such as a battery and/or accumulator and/or can be supplied inductively or conductively with electrical energy during a trip. In the case of a conductive supply, a conductor line is laid along the rails; in the case of an inductive supply, a primary conductor is laid along the trajectory, e.g., along the rail, which conductor can be inductively coupled to a secondary winding arranged on the mobile part, to which secondary winding a capacitor is connected in series or in parallel such that the resonance frequency of the thusly resulting resonant circuit matches the frequency of the alternating current supplied to the primary conductor. The primary conductor is arranged as an elongated line conductor including of HF Litz wire, in which the frequency is between 10 kHz and 1000 kHz.

According to example embodiments, the mobile part has a tracking sensor or the mobile part is a rail vehicle. The advantage is that the mobile part moves one-dimensionally and therefore the calculations can be readily performed.

Further features and aspects of example embodiments of the present invention are explained in more detail below with reference to the appended schematic Figure.

### BRIEF DESCRIPTION OF THE DRAWING

FIG. 1 schematically illustrates a system according to an example embodiment of the present invention.

### DETAILED DESCRIPTION

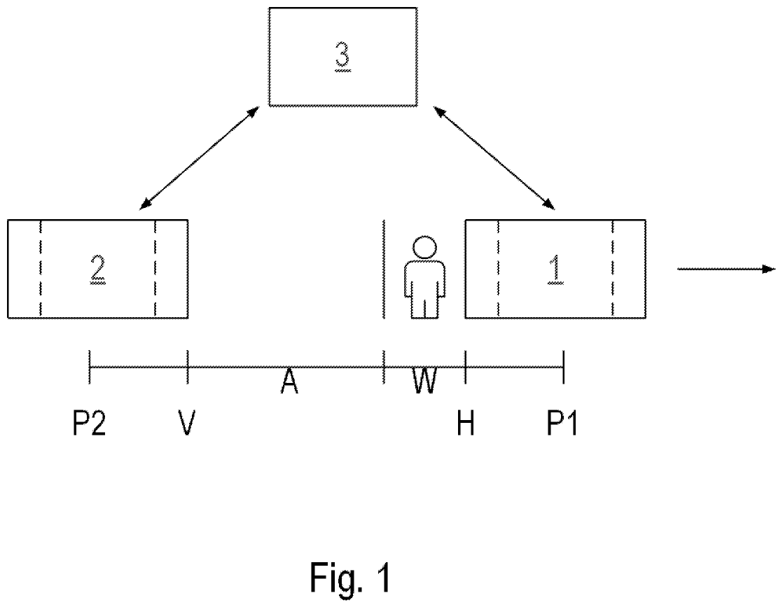

A system according to an example embodiment of the present invention is shown schematically in FIG. 1.

As illustrated in FIG. 1, a first mobile part 1 is followed by a second mobile part 2, wherein a safe distance is ensured.

For this purpose, the first mobile part 1 detects its position P1 with a first position detection system and the second mobile part 2 detects its position P2.

The two mobile parts (1, 2) are, for example, track-guided or rail-guided.

A coding region provided with coded regions is, for example, arranged along the trajectory of the mobile parts (1, 2), e.g., along the rails, as the position detection system. Each of the coded regions encodes its respective position.

The mobile parts have a respective length depending on the load picked up. It is thus possible for the first mobile part 1 to determine the position H of its rear edge and the second mobile part 2 to determine the position V of its front edge.

In addition, the first mobile part 1 detects its direction of movement R1 and its speed V1, and the second mobile part 2 detects its direction of movement R2 and its speed V2.

Direction monitoring is carried out in the first mobile part 1. The direction of movement R1 is monitored for forward travel. As soon as a reverse movement of the first mobile part 1 is detected by the mobile part itself, an error signal is generated and reported, which makes it possible to stop the mobile parts (1, 2) of the system.

Each of the mobile parts (1, 2) reports its position P1 or P2, respectively, to a controller 3. For this purpose, there is a wireless data exchange connection between the controller 3 and the mobile parts (1, 2).

To maintain the safe distance, the first mobile part 1 first reports its position P1 and, for example, the position of its rear edge H to the controller 3, which determines the next-closest mobile part 2 from all the position data received from the mobile parts (1, 2).

The controller 3 transmits the data received from the first mobile part 1, such as position P1 and rear edge position H, to the second mobile part 2.

Considering its detected speed V2 and the maximum braking acceleration available to it, the second mobile part calculates a braking distance A, to which a safety distance is also added, which takes into account existing response times, dead times, etc. The particular position that is compared with the rear edge position H of the first mobile part 1 is determined by adding this braking distance A determined in this manner to the position P2 of the second mobile part 2 detected by the second mobile part 2 itself and adding a further safety region W intended for a person. As soon as an impermissible amount of deviation with respect to this rear edge position H is undershot by the position resulting from the addition, an error signal, e.g., an STO signal, is generated and the error is reported, e.g., the drives of the mobile part are brought to a standstill.

In other words, the front edge position V of the second mobile part 2 is monitored for collision with the rear edge position H of the first mobile part 1.

If the distance between the rear edge position H and the front edge position V exceeds a threshold value s, e.g., is sufficiently large enough, the direction monitoring of the first mobile part 1 is switched off. Reverse travel of the first mobile part 1 is thus permitted. This can be used, for example, in a maintenance area or in a siding.

Reverse travel of the first mobile part 1 can be controlled with a hand-held control device. When direction monitoring is switched on, the first mobile part 1 cannot be controlled with the hand-held control device.

The specified provisions and monitoring are carried out using secure technology. Improved safety can thus be achieved, e.g., a higher safety category.

### LIST OF REFERENCE CHARACTERS

1 First mobile part

2 Second mobile part

3 Controller

P1 Position of the first mobile part 1

P2 Position of the first mobile part 2

V Front edge of the second mobile part 2

H Rear edge of the first mobile part 2

A Braking distance with safety distance

W Safety region

V1 Speed of the first mobile part 2

V2 Speed of the second mobile part 2

1-15. (canceled)

16. A method for operating a system including a first mobile part, additional mobile parts, a stationary controller, a data exchange connection between the controller and the first mobile part, and a data exchange connection between the controller and the additional mobile parts, comprising:
detecting, by the first mobile part, a position of the first mobile part and/or determining, by the first mobile part, a position of a rear edge of the first mobile part;
transmitting, by the first mobile part, to the controller, determined values for the position of the first mobile part and/or the position of the rear edge of the first mobile part;
detecting, by each additional mobile part, a position of the respective additional mobile part and/or a position of a front edge of the respective additional mobile part;
transmitting, by each additional mobile part, to the controller, determined values of the position of the respective additional mobile part and/or the position of the front edge of the respective additional mobile part;
determining, by the controller, the additional mobile part most closely adjacent to and following the first mobile part;
transmitting, by the controller, the position of the first mobile part and/or the position of the rear edge of the first mobile part to the additional mobile part most closely adjacent to and following the first mobile part;
adding, by the additional mobile part most closely adjacent to and following the first mobile part, a respective braking distance, to which a safety distance and a safety range are added, to position the position of the additional mobile part most closely adjacent to and following the first mobile part and/or the front edge of a next-closest, following additional mobile part as a calculated position; and
monitoring, by the additional mobile part most closely adjacent to and following the first mobile part, the calculated position for collision with the rear edge of the first mobile part.

17. The method according to claim 16, wherein the braking distance, the safety distance, and/or the safety range take into account existing response times and/or dead times.

18. The method according to claim 16, wherein a direction of travel of the first mobile part is detected and transmitted to the controller, and/or wherein a direction of travel is stored in the controller as a function of the position of the first mobile part and is transmitted to the first mobile part and/or is provided to the mobile part as a target direction of travel.

19. The method according to claim 16, wherein each additional mobile part includes a computer and a camera adapted to recognize coded regions to determine the position, the next-closest, following mobile includes has a computer and a camera adapted to recognize coded regions for determining the position, and the coded regions are arranged successively parallel to a direction of rails.

20. The method according to claim 16, wherein the position of the first mobile part is detected by a camera, connected to a computer, of the first mobile part, and the position of the next-closest, following mobile part is detected by a further camera, connected to a further computer, of the next-closest, following mobile part, coded regions being arranged successively parallel to a direction of rails.

21. The method according to claim 16, wherein a safety region of the system has a volume of more than one cubic meter.

22. The method according to claim 16, wherein, for the detection of the position, the first mobile part has a camera, in a sensitive region of which coded regions are arranged successively parallel to the direction of travel.

23. The method according to claim 22, wherein the coded regions form a stationary coding region.

24. The method according to claim 16, further comprising evaluating a chronological sequence of detected positions to detect speed.

25. The method according to claim 19, wherein each coded region includes information relating to relative position and/or rough positioning.

26. The method according to claim 19, wherein an evaluation unit determines a distance of an image to a center of the image from images taken by the camera of a first one of the coded regions and, from the determined distance, a shift of the camera to that position and/or precise positioning of the camera, in which a viewing direction of the camera onto the first one of the coded regions and/or onto a center of the first one of the coded regions occurs as viewed from the center of the image.

27. The method according to claim 16, further comprising monitoring a direction of travel detected on the first mobile part when a distance between the position of the rear edge of the first mobile part and the position of the front edge of the next-closest, following mobile part undershoots a threshold value.

28. The method according to claim 27, wherein the direction of travel detected on the first mobile part is not monitored when the distance between the position of the rear edge of the first mobile part and the position of the front edge of the next-closest, following mobile part exceeds the threshold value, the first mobile part is adapted to be controlled by a hand-held control device.

29. The method according to claim 28, wherein the first mobile part is adapted to be controlled by the hand-held control device in a reverse direction, and the hand-held control device is connected to the first mobile part by an electrical cable.

30. The method according to claim 16, wherein the first mobile part determines the position of the rear edge from the position of the first mobile part.

31. The method according to claim 16, wherein the first mobile part determines the position of the rear edge from the position of the first mobile part as a function of the position of the first mobile part in the system, and different loads are picked up by the first mobile part in different positions.

32. The method according to claim 16, wherein the next-closest, mobile part determines the position of the rear edge of the next-closest, mobile part from position of the next-closest mobile part as a function of the position of the next-closest, mobile part in the system.

33. A system, comprising:
rail-guided mobile parts; and
coded regions extending parallel to a direction of rails on which the rail-guided mobile parts are guided;
wherein the system is adapted to perform the method recited in claim 16.

34. The system according to claim 33, wherein each the mobile part includes an electric motor drive.

35. The system according to claim 33, wherein at least one of the mobile parts includes a tracking sensor.

36. The system according to claim 33, wherein at least one of the mobile parts is arranged as a rail vehicle.
